(19) United States
(12) Patent Application Publication
(10) Pub. No.: US 2017/0102879 A1
(43) Pub. Date: Apr. 13, 2017

(54) DESCRIPTOR DATA MANAGEMENT

(71) Applicant: SANDISK TECHNOLOGIES INC., PLANO, TX (US)

(72) Inventors: SHAY BENISTY, BEER SHEVA (IL); TAL SHARIFIE, LEHAVIM (IL)

(73) Assignee: SANDISK TECHNOLOGIES INC.

(21) Appl. No.: 14/880,844

(22) Filed: Oct. 12, 2015

(51) Int. Cl. G06F 3/06; G06F 12/02

(52) U.S. Cl. CPC G06F 3/0604; G06F 3/0638; G06F 3/0688; G06F 12/0238; G06F 2212/1044

(57) ABSTRACT

A data storage device includes a non-volatile memory device coupled to a controller. The controller includes a first memory. The controller is configured to receive, from an access device, descriptor data indicating addresses and sizes of portions of a second memory of the access device and to select a portion from the portions. The controller is further configured to write first data to the first memory. The first data indicates an address and a size of the selected portion. The controller is also configured to send second data to the access device to be stored at the second memory. The second data indicates a first address and a second address. The first address corresponds to a first segment of a plurality of segments of a first portion of the portions that is distinct from the selected portion. The second address corresponds to a second segment of the plurality of segments.

### FIELD OF THE DISCLOSURE

The present disclosure is generally related to electronic devices and more particularly to descriptor data management.

### BACKGROUND

Storage devices enable users to store and retrieve data. For example, some storage devices include non-volatile memory devices used to store data (such as user data). These storage devices often also include a controller that performs operations such as coordinating access to the non-volatile memory and error detection/correction. The controller may include or have access to memory that is used to store data (e.g., management data) used for operations performed by the controller. Often, the memory used by the controller to store management data is a volatile memory. Volatile memory included in the controller adds cost to the storage device. However, if the controller does not have access to a volatile memory of sufficient size to store management data, latency for certain operations may be increased.

### BRIEF DESCRIPTION OF THE DRAWINGS

FIG. 1 is a diagram of a particular illustrative example of a system that includes a device, such as a data storage device;

FIG. 2 is a diagram of a particular illustrative example of components that may be included in the device of FIG. 1;

FIG. 3 is a diagram of a particular illustrative example of components that may be included in the device of FIG. 1;

FIG. 4 is a diagram of a particular illustrative example of a system that includes the device of FIG. 1; and

FIG. 5 is a diagram of a particular illustrative example of a method of operation of the device of FIG. 1.

### DETAILED DESCRIPTION

In some implementations, an access device (such as a host device) may be coupled to or have access to a data storage device. For example, the data storage device may include a non-volatile memory, and the access device may use the data storage device to store user data or other data. The access device may also include or have access to other memory (e.g., volatile memory of the access device). To facilitate operation of the data storage device, the access device may designate portions of the memory of the access device for use by a controller of the data storage device. For example, portions of the memory of the access device may be allocated for use as host memory buffers (HMBs). The controller may use HMBs to store management data. The management data may include flash translation layer (FTL) tables, as an illustrative, non-limiting example. The controller may thus have access to additional volatile memory without additional cost.

In some implementations, the allocated portions of the memory of the access device may be non-contiguous. For example, the allocated portions may include multiple storage locations of the memory of the access device, where at least some of the storage locations are not adjacent to others of the storage locations. Use of non-contiguous storage locations may enable a larger combined amount of memory to be accessible to the controller as compared to a largest available block of contiguous storage locations.

The access device may identify the portions of the memory of the access device that are allocated for use by the controller (e.g., “allocated portions” of the memory of the access device) of the data storage device using descriptor data. The descriptor data may be generated by the access device, and at least a portion of the descriptor data may be provided to the controller. For example, the access device may provide descriptor data to the controller during or after initialization of the data storage device or during or after allocation of the portions of the memory (e.g., during or after an HMB initialization process). In a particular aspect, the controller may send a request to the access device to allocate memory portions for use by the controller. The request may indicate a total requested size (e.g., 128 megabytes (MB)) of the allocated memory portions. The access device may maintain a list of available (e.g., unallocated) memory portions and corresponding sizes. The access device may select portions from the list such that a sum of the sizes of the selected portions is greater than or equal to the total requested size. For example, the access device may select a largest portion of the available portions, which may have a size less than or equal to the total requested size. Similarly, the access device may select additional portions from the list until a sum of sizes of the selected portions is greater than or equal to the total requested size. The access device may allocate the selected portions for use by the controller.

A portion of the memory of the access device may include a set of adjacent storage locations. A first storage location of the set may be used to store first data and a second storage location of the set may be used to store second data. A first size of the first storage location may be the same as or distinct from a second size of the second storage location. A starting address of the portion may correspond to an address of an initial storage location of the set. An address of a “subsequent” storage location (e.g., a storage location having a numerically larger address than one or more other storage locations of the set) may correspond to a sum of the starting address and the sizes of the other storage locations of the set that “precede” the subsequent storage location.

The descriptor data (e.g., an HMB descriptor list) may include multiple entries. Each entry may include information sufficient to enable addressing of storage locations of an allocated portion of the memory of the access device. For example, each entry may indicate an address of a storage location associated with a particular allocated portion (e.g., an initial storage location of a set of adjacent storage locations of a particular allocated portion) and a size of the particular allocated portion.

The controller of the data storage device may use the allocated portions as HMBs to store data (e g, management data) or other data used by the controller. Since the controller can store data at the HMBs, the controller can have a smaller volatile memory, thereby reducing cost of the storage device. However, since data stored in the HMBs is at the access device, latency associated with the controller may be increased by using the HMBs (relative to storing the same data at a volatile memory of the controller). For example, since the HMBs may correspond to non-contiguous storage locations, to perform a memory operation (e.g., a read or write operation) for a particular HMB, the controller searches the descriptor data to find the address of the storage locations associated with the particular HMB. The present disclosure describes systems and methods to manage (or manipulate) the descriptor data to decrease latency associated with using the HMBs.

In a first approach (e.g., a descriptor data approach), the controller may store the descriptor data at a volatile memory of the controller. To access a particular HMB, the controller may perform a linear search through the descriptor data for an address (e.g., a target address) corresponding to a particular HMB. Because the allocated portions of the memory of the access device may be non-contiguous and the descriptor data includes information associated with each allocated portion, the linear search can be time consuming. For example, to determine whether the target address is within a particular allocated portion, the controller may determine a range of addresses associated with the particular allocated portion (e.g., based on an initial address of the allocated portion and a size of the allocated portion). If the target address is not within the particular allocated portion, the controller may determine another range of addresses associated with a next allocated portion to determine whether the target address is within the next allocated portion. Successive allocated portions may be searched until the target address is identified, or until the search fails.

In some cases, the descriptor data may be too large for all of the descriptor data to be stored together in the volatile memory (“controller memory”) of the controller. In such cases, the controller may store the descriptor data at one or more of the allocated portions of the memory of the access device. In this case, the access device may provide an address of the descriptor data to the controller to enable the controller to access the descriptor data. The controller may store the address of the descriptor data in the controller memory. The controller may access the descriptor data from the allocated portions of the memory of the access device to determine a target address corresponding to a particular HMB. When the controller accesses the descriptor data from the access device, performing a linear search on the descriptor data may involve a large number of data transfers from the access device. For example, if the target address is within an allocated portion that corresponds to a last entry of the descriptor data, the controller may receive data corresponding to each entry of the descriptor data from the access device to reach the last entry. Thus, at least when a size of the descriptor data exceeds a size of the volatile memory of the controller, the linear search approach may increase latency.

In a second approach (e.g., a split-data approach), latency may be reduced by balancing controller memory utilization and data transfers with the access device. For example, the controller may divide the descriptor data into at least two subsets of descriptor data. In this example, the controller may retain a first subset (e.g., first data) of the descriptor data at the controller memory and another subset (e.g., second data) of the descriptor data may be stored at the access device. The first data may correspond to a first subset of entries of the descriptor data, and the second data may correspond to a remaining subset of entries of the descriptor data.

In a particular implementation, the first data may correspond to the larger continuous portions of the allocated portions and the second data may correspond to remaining portions of the allocated portions. In a particular example, the controller or the access device may sort entries of the descriptor data based on sizes of corresponding portions and may generate the first data and the second data based on the sorted descriptor data.

Additionally, in some implementations, each entry of the second data may be associated with the same size portion of the memory of the access device. That is, each allocated portion identified in the second data may be the same size. This may be accomplished by subdividing some allocated portions into two or more segments (e.g., smaller portions), and generating an entry in the second data for each segment. For example, each entry of the second data may correspond to a particular size (e.g., a host page size (HPS) of 4 kilobytes (KB)). In this example, if a particular entry of the descriptor data corresponds to a first portion of a size greater than the HPS, such as 8 KB, the first portion may be associated with multiple entries in the second data, where each entry is associated with a 4 KB portion. For example, the second data may include a first entry corresponding to a first 4 KB segment of the first portion and a second entry corresponding to a second 4 KB segment of the first portion. The first entry may indicate a first address of the first 4 KB segment and the second entry may indicate a second address of the second 4 KB segment. Since each entry of the second data is the same size, the entries of the second data do not need to include size information.

The controller may map addresses of the allocated portions to a contiguous memory range that is addressable using an offset addressing scheme. For example, the controller may calculate memory offsets within the contiguous memory range that correspond to the allocated portions based on the sorted descriptor data. To illustrate, the controller may assign a first memory offset (e.g., 0) to a first portion associated with an initial entry of the sorted descriptor data. For each subsequent entry of the sorted descriptor data, the controller may assign a particular memory offset to a particular portion associated with the subsequent entry based on a memory offset and a size associated with a previous entry of the sorted descriptor data. The controller may provide access to the allocated portions to a memory device based on the contiguous memory range (e.g., using memory offsets) and may map memory offsets used by the memory device to memory addresses used by the access device. For example, the memory device may send an access request (e.g., a read request or a write request) to the controller indicating a target offset. The controller may map the target offset to a target address and may send a second access request to the access device indicating the target address. For example, the controller may send a write request (or a read request) to the access device indicating the target address in response to receiving a write request (or a read request) from the memory device indicating the target offset.

The controller may determine that the target address is associated with the first data (that is stored locally at the controller) in response to determining that the target offset is less than a memory offset that is associated with an initial entry of the second data. Alternatively, the controller may determine that the target address is associated with the second data (that is stored at the access device) in response to determining that the target offset is greater than or equal to the memory offset that is associated with the initial entry of the second data.

Since entries of the second data may correspond to equal-sized portions, the controller can calculate (or otherwise determine) a target address associated with the second data by performing a single lookup in the entries of the second data. For example, the controller may determine that an nth entry of the second data corresponds to a target offset based on the target offset and the size of the equal-sized segments (e.g., n=(target offset−offset of an initial entry of the second data)/size of each segment). To illustrate, the controller may determine that a third entry (n=2) corresponds to a target offset (e.g., 8 KB) based on the target offset and the size of the equal sized segments (e.g., 2=(8 KB-0 KB)/4 KB). A first entry (n=0) of the second data may correspond to a first offset (e.g., 0 KB). A second entry (n=1) of the second data may correspond to a second offset (e.g., 4 KB=0 KB+4 KB) that is equal to a sum of the first offset and the size of the equal sized segments. The third entry (n=2) may correspond to the target offset (e.g., 8 KB=4 KB+4 KB) that is equal to a sum of the second offset and the size of the equal sized segments. The controller may determine the target address based on an address indicated by the nth entry. Additionally, since the first data only includes descriptor data associated with the larger contiguous allocated portions, the controller can efficiently search the first data to identify entries in the first data. For example, a linear search may be used. The first data may include a few entries (e.g., 2 entries) corresponding to the larger continuous portions of the memory of the access device. Performing a linear search of a small number of entries (e.g., 2 entries) in the controller memory may be faster than a single lookup of the memory of the access device. Including entries corresponding to the larger continuous portions of the memory in the first data may reduce a number of entries in the second data. For example, a larger continuous portion (e.g., 1 MB) includes a first number of equal-sized segments (e.g., 250=1 MB/4 KB) and a smaller continuous portion may include a second number of entries (e.g., 2=8 KB/4 KB) that is smaller than the first number. The first data may include a single entry corresponding to the larger continuous portion and the second data may store the second number of entries corresponding to the smaller continuous portion. Storing entries corresponding to the larger continuous portions in the first data may thus reduce the size of the second data.

In a third approach (e.g., a modified descriptor data approach), entries of the descriptor data may include offsets. In this approach, the controller may perform a search (e.g., a binary search) of the descriptor data to determine a target address corresponding to a target offset. For example, the controller may determine that a middle entry (e.g., a first entry for a binary search) of the descriptor data corresponds to a first offset (e.g., 2 MB). The first entry may indicate the first offset, a first address, and a first size (8 KB) of a first portion. The controller may determine that the target offset (e.g., 2 MB+4 KB) matches the first offset (e.g., 2 MB) in response to determining that the target offset (e.g., 2 MB+4 KB) is greater than or equal to the first offset (e.g., 2 MB) and less than a sum of the first offset and the first size (e.g., 2 MB+8 KB). The controller may determine the target address based on the first address in response to determining that the target offset matches the first offset (e.g., target address=the first address+target offset−first offset). Alternatively, the controller may, in response to determining that the target offset does not match the first offset, select a second offset (corresponding to a second entry for the search) to compare to the target offset based on whether the target offset is less than or greater than the first offset. For example, the second entry may correspond to a middle entry between an initial entry of the descriptor data and the first entry if the target offset (e.g., 1 MB) is less than the first offset (e.g., 2 MB). Alternatively, the second entry may correspond to a middle entry between the first entry and a last entry of the descriptor data if the target offset (e.g., 2 MB+10 KB) is greater than or equal to the sum of the first offset and the first size (e.g., 2 MB+8 KB). The controller may determine the target address based on a second address indicated by the second entry in response to determining that the target offset matches the second offset (e.g., target address=second address+target offset−second offset). The binary search of the descriptor data that includes offsets may involve fewer data transfers with the access device than a linear search.

Particular aspects of the disclosure are described below with reference to the drawings. In the description, common or similar features or components may be designated by common reference numbers. As used herein, “exemplary” may indicate an example, an implementation, and/or an aspect, and should not be construed as indicating a preference or a preferred implementation.

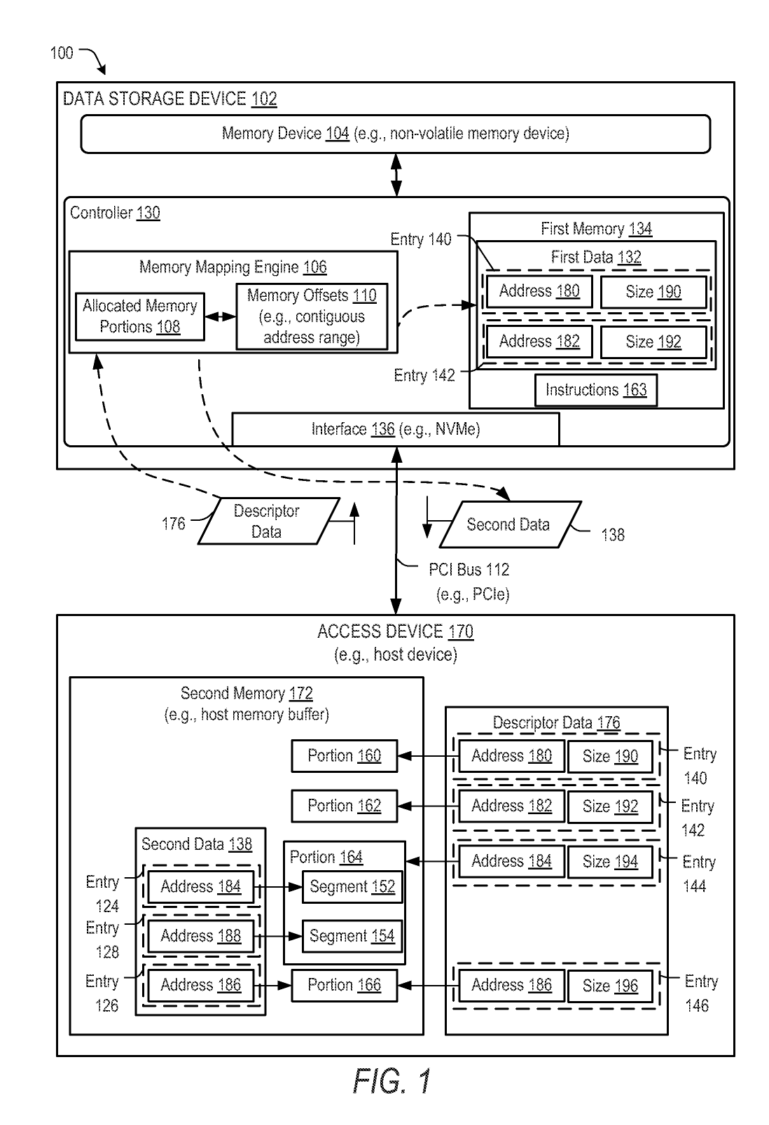

Referring to FIG. 1, a particular illustrative example of a system is depicted and generally designated 100. The system 100 includes a data storage device 102 and an access device 170 (e.g., a host device, a test device, a computing device, or a combination thereof). The data storage device 102 and the access device 170 may be operationally coupled via a connection (e.g., a peripheral component interconnect (PCI) bus 112). The PCI bus 112 may be compliant with a PCI Express (PCIe) specification. In some implementations, the data storage device 102 corresponds to or includes a solid state drive (SSD) data storage device that is configured to be embedded within the access device 170 or a removable flash memory data storage device that is configured to be removably coupled to the access device 170. In other implementations, the data storage device 102 corresponds to another device, such as an application-specific integrated circuit (ASIC) or a system-on-chip (SoC) device, as illustrative examples.

The data storage device 102 may include a memory device 104 (e.g., a non-volatile memory device). The memory device 104 may include a flash memory (e.g., a NAND flash memory) or a resistive memory, such as a resistive random access memory (ReRAM), as illustrative examples. The memory device 104 may have a three-dimensional (3D) memory configuration. As used herein, a 3D memory device may include multiple physical levels of storage elements (instead of having a single physical level of storage elements, as in a planar memory device). As an example, the memory device 104 may have a 3D vertical bit line (VBL) configuration. In a particular implementation, the memory device 104 is a non-volatile memory having a 3D memory array configuration that is monolithically formed in one or more physical levels of arrays of memory cells having an active area disposed above a silicon substrate. Alternatively, the memory device 104 may have another configuration, such as a two-dimensional (2D) memory configuration or a non-monolithic 3D memory configuration (e.g., a stacked die 3D memory configuration).

In some implementations, the system 100, the data storage device 102, the memory device 104, or a combination thereof, may be integrated within a network-accessible data storage system. Examples of network-accessible data storage systems include an enterprise data system, a network-attached storage (NAS) system, or a cloud data storage system, as illustrative examples.

The data storage device 102 may include a controller 130 coupled to the memory device 104. In some implementations, the controller 130 corresponds to a semiconductor die that includes components of the controller 130. The controller 130 may include an interface 136 (e.g., a memory interface) to the memory device 104. The interface 136 may be compliant with a non-volatile memory express (NVMe) specification. The controller 130 may include a memory mapping engine 106, first memory 134 (e.g., random access memory (RAM)), or both.

The memory mapping engine 106 may be implemented by software (e.g., instructions) executable by a processor (not shown) of the controller 130 to perform operations described herein. Alternatively, the memory mapping engine 106 may include hardware (e.g., one or more circuits) configured to perform operations described herein. The memory mapping engine 106 may be configured to map addresses of allocated memory portions 108 to a contiguous address range that is addressable using memory offsets 110, as described herein. The first memory 134 may be configured to store one or more instructions 163. In a particular implementation, the instructions 163, when executed by a processor of the controller 130, enables the processor to perform operations described herein.

The access device 170 may include a processor (not shown) and memory accessible to the processor. For example, the memory of the access device 170 may include a second memory 172. At least a portion of the second memory 172 may be designated or allocated by the access device 170 for use by the controller 130 of the data storage device 102. For example, at least a portion of the second memory 172 may be allocated for use as a host memory buffer (HMB). The second memory 172 may include volatile memory or non-volatile memory.

During operation, the access device 170 may allocate one or more portions (e.g., a portion 160, a portion 162, a portion 164, and a portion 166) of the second memory 172 for use by the controller 130. For example, the access device 170 may allocate the portions 160-166 during an initialization process. The portions 160-166 may be non-contiguous (e.g., non-adjacent storage locations of the second memory 172 that are separated from each other by at least one non-allocated portion of the second memory 172).

The access device 170 may generate descriptor data 176 (e.g., a list) including one or more entries, and each entry may be associated with one of the portions 160-166. For example, the descriptor data 176 may include an entry 140 corresponding to the portion 160, an entry 142 corresponding to the portion 162, an entry 144 corresponding to the portion 164, and an entry 146 corresponding to the portion 166. In FIG. 1, the descriptor data 176 is illustrated as stored in a table; however, in other implementations, the descriptor data 176 may be stored in another data structure. Additionally, although four portions 160-166 and four corresponding entries 140-146 are shown in FIG. 1, in some implementations, more than four portions of the second memory 172 may be allocated for use by the controller 130, in which case the descriptor data 176 may include more than four entries. Conversely, in some implementations, fewer than four portions of the second memory 172 may be allocated for use by the controller 130, in which case the descriptor data 176 may include fewer than four entries. Each of the entries of the descriptor data 176 may indicate an address and a size of a corresponding allocated portion. For example, the entry 140 may indicate an address 180 of the portion 160 and a size 190 of the portion 160, the entry 142 may indicate an address 182 of the portion 162 and a size 192 of the portion 162, the entry 144 may indicate an address 184 of the portion 164 and a size 194 of the portion 164, and the entry 146 may indicate an address 186 of the portion 166 and a size 196 of the portion 166.

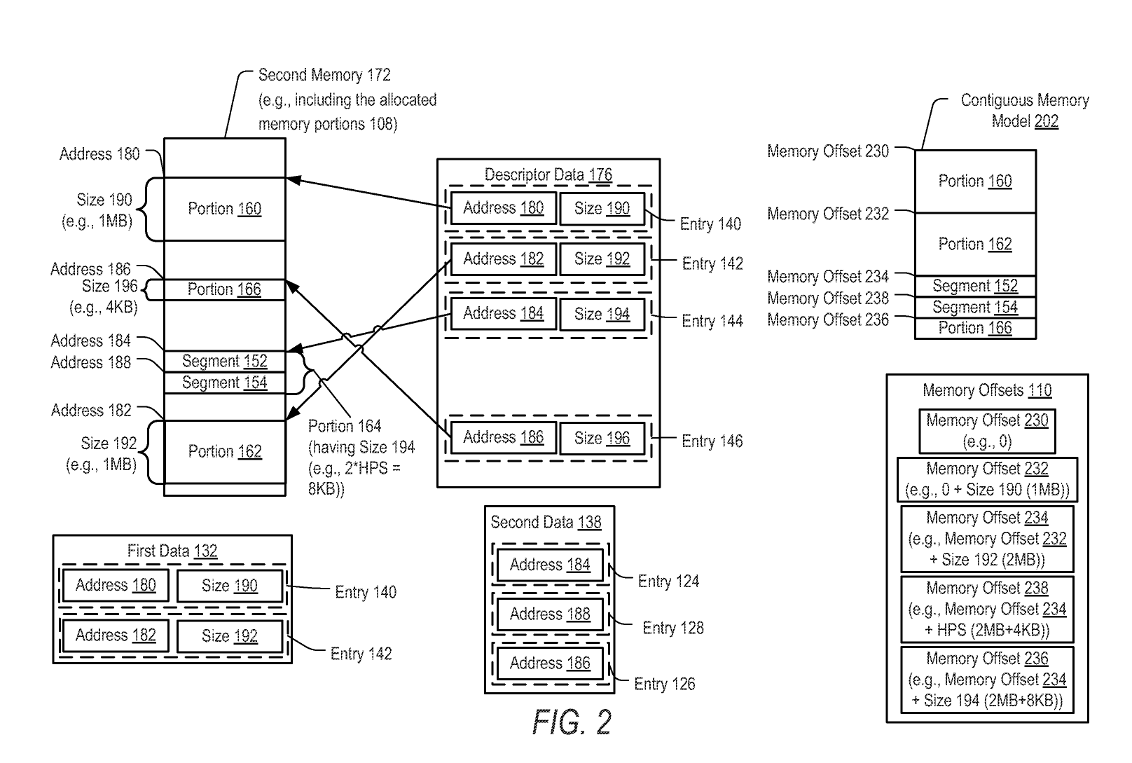

The access device 170 may provide the descriptor data 176, via the PCI bus 112 and the interface 136, to the data storage device 102. For example, the access device 170 may provide the descriptor data 176 to the data storage device 102 during an initialization process, in response to a request from the data storage device 102, or both. The memory mapping engine 106 may generate the memory offsets 110 by mapping addresses 180-186 of the entries 140-146 (corresponding to non-contiguous portions of the second memory 172) to a contiguous address range, as further described with reference to FIG. 2. For example, the memory mapping engine 106 may generate a memory offset corresponding to each entry of the entries 140-146. To illustrate, the memory mapping engine 106 may sort the entries 140-146 of the descriptor data 176 based on the sizes 190-196. The memory mapping engine 106 may generate a memory offset corresponding to each of the sorted entries (e.g., the entries 140-146), as further described with reference to FIG. 2.

FIG. 1 may illustrate a “split-data” approach, as described herein. The memory mapping engine 106 may select a threshold number (e.g., 2) of portions from among the portions 160-166. For example, the memory mapping engine 106 may select the portion 160 and the portion 162 based on a size of the first memory 134, the size 190, and the size 192. To illustrate, the sizes 190-192 may indicate that the portions 160-162 are the larger portions of the allocated memory portions 108. The threshold number may be a default value that indicates a maximum number of descriptor data entries to be stored at the first memory 134. The threshold number may be based on the size of the first memory 134 (e.g., threshold number=size of an available portion of the first memory 134/element size). The element size may indicate a size of data (e.g., an element or an entry) to be stored in the first memory 134 corresponding to each of the portions 160-162. The memory mapping engine 106 may generate first data 132 (e.g., a list or a table) corresponding to the selected portions (e.g., the portions 160-162), second data 138 (e.g., a list or a table to be stored in the second memory 172) corresponding to remaining portions (e.g., the portions 164-166), or both. For example, the first data 132 may include a first element (e.g., the entry 140) corresponding to the portion 160, a second element (e.g., the entry 142) corresponding to the portion 162, or both. The second data 138 may include one or more entries (e.g., an entry 124, an entry 126, an entry 128, or a combination thereof) corresponding to the portions 164-166, as described herein. The memory mapping engine 106 in the controller 130 may write the first data 132 to the first memory 134. For example, the memory mapping engine 106 may perform a write operation that causes the first data 132 to be stored in storage cells of the first memory 134.

Each entry of the second data 138 may correspond to an equal-sized segment of the portions 164-166. The equal-sized segment may have a particular size (e.g., a host page size (HPS) of 4 kilobytes (KB)). Data may be retrieved from the second memory 172 in equal-sized blocks called pages. HPS may indicate a size of a page of the second memory 172. The portion 164 may include a segment 152, a segment 154, or both. Each of the segments 152-154 may be of the particular size (e.g., HPS, such as 4 KB). The memory mapping engine 106 may generate one or more entries for each portion, where a number of entries corresponding to each portion is based on a size of the portion and the particular size. For example, the memory mapping engine 106 may generate a first number of entries (e.g., 2 entries) corresponding to the portion 164 based on the size 194 (e.g., 8 KB) and the particular size (e.g., 4 KB). The first number of entries may include the entry 124 corresponding to the segment 152, the entry 128 corresponding to the segment 154, or both. The memory mapping engine 106 may generate a second number of entries (e.g., 1 entry) corresponding to the portion 166 based on the size 196 (e.g., 4 KB) and the particular size (e.g., 4 KB). For example, the entry 126 may correspond to the portion 166.

The memory mapping engine 106 may determine an address of a segment corresponding to each entry (e.g., each table entry) of the second data 138 based on an address of a portion that includes the segment. For example, the memory mapping engine 106 may determine an address of an nth segment of a portion based on the address of the portion and the particular size (e.g., address of the portion+n*particular size). To illustrate, the segment 152 may be a first segment (e.g., n=0) of the portion 164. The memory mapping engine 106 may determine an address of the segment 152 based on the address 184 and the particular size (e.g., the address 184+(0*HPS)) and may add the determined address (e.g., the address 184) into the entry 124. The memory mapping engine 106 may determine an address 188 of the segment 154 (e.g., n=1) based on the address 184 and the particular size (e.g., the address 184+(1*HPS)) and may add the determined address (e.g., the address 188) into the entry 128. An entry (e.g., the entries 124-128) may not include size information of a corresponding segment. The memory mapping engine 106 may provide the second data 138, via the interface 136 and the PCI bus 112, to the access device 170. The access device 170 may store the second data 138 in the second memory 172. For example, the access device 170 may store the second data 138 in the allocated memory portions 108 (e.g., one or more of the portions 160-162) that are indicated in the first data 132.

The memory device 104 may access the allocated memory portions 108 based on the memory offsets 110, as further described with reference to FIG. 2. For example, the memory device 104 may request access to the allocated memory portions 108 using corresponding memory offsets, as further described with reference to FIG. 2. The controller 130 may provide a target offset to the memory device 104 as an address (e.g., a logical address) of a memory location in the allocated memory portions 108. The memory device 104 may send a memory access request (e.g., a read request or a write request) to the memory location using the target offset.

The memory mapping engine 106 may determine a target address (e.g., a physical address of a location in the second memory 172) corresponding to the target offset based on the first data 132, the second data 138, or both. For example, the memory mapping engine 106 may determine the target address by performing a linear search of the first data 132 in response to determining that the target offset is less than a memory offset corresponding to an initial entry (e.g., the entry 124) of the second data 138, as further described with reference to FIG. 2. Alternatively, the memory mapping engine 106 may determine the target address by performing a binary search of the second data 138 in response to determining that the target offset is greater than or equal to the memory offset corresponding to the initial entry (e.g., the entry 124) of the second data 138.

The controller 130 may perform a memory operation based on the target address. For example, a first write request from the memory device 104 may indicate that first data is to be written to a memory location corresponding to a target offset. The memory mapping engine 106 may determine a target address corresponding to the target offset and may send a second write request to the access device 170. The second write request may indicate that the first data is to be written to the target address. As another example, a first read request from the memory device 104 may indicate that data is to be read from a memory location corresponding to a target offset. The memory mapping engine 106 may determine a target address corresponding to the target offset and may send a second read request to the access device 170. The second read request may indicate that data is to be read from the target address. The access device 170 may provide second data from the target address to the controller 130. The memory mapping engine 106 may provide the second data to the memory device 104.

Advantageously, in the split-data approach, the controller 130 may balance utilization of the first memory 134 and data transfers with the access device 170 by maintaining the first data 132 in the first memory 134 of the controller 130 and maintaining the second data 138 in the second memory 172 of the access device 170. The first data 132 may include a few (e.g., up to a threshold number of) entries corresponding to some of the larger portions of the allocated memory portions 108. The second data 138 may include entries corresponding to remaining portions of the allocated memory portions 108. The memory mapping engine 106 may determine a target address corresponding to a target offset by performing a linear search on the first data 132 that is stored locally on the controller 130 or by performing a binary search of the second data 138 that is stored at the access device 170. The binary search may reduce a number of data transfers with the access device 170 as compared to a linear search of the second data 138.

Referring to FIG. 2, illustrative aspects of the first data 132, the second data 138, the second memory 172, the descriptor data 176, and the memory offsets 110 are shown. The second memory 172 may include the allocated memory portions 108. For example, the second memory 172 may include the portion 160 starting from the address 180 and having the size 190 (e.g., 1 MB), the portion 166 starting from the address 186 and having the size 196 (e.g., HPS), the portion 164 starting from the address 184 and having the size 194 (e.g., 2*HPS), and the portion 162 starting from the address 182 and having the size 192 (e.g., 1 MB). The address 186 may be subsequent to (e.g., have a larger numerical value than) the address 180. The address 184 may be subsequent to the address 186. The address 182 may be subsequent to the address 184.

The memory mapping engine 106 may map addresses of the allocated memory portions 108 to the memory offsets 110. For example, the memory mapping engine 106 (or the access device 170) may sort the entries 140-146 of the descriptor data 176 based on the sizes 190-196. To illustrate, subsequent to sorting, the portion 164 having the size 194 (e.g., 2*HPS(=8 KB)) may be subsequent to (e.g., later in a sorting order than) the portion 160 having the size 190 (e.g., 1 MB) and the portion 162 having the size 192 (e.g., 1 MB). The portion 166 having the size 196 (e.g., HPS(=4 KB)) may be subsequent to the portion 164. The memory mapping engine 106 may determine the memory offsets 110 of the allocated memory portions 108 based on the sorted entries 140-146 according to a contiguous memory model 202. For example, the memory mapping engine 106 may assign a memory offset 230 (e.g., 0) to the portion 160. The memory offset 230 may be a default value (e.g., 0). The memory mapping engine 106 may assign a memory offset 232 to the portion 162. The memory offset 232 (e.g., 1 MB) may be a sum of the memory offset 230 and the size 190. The memory mapping engine 106 may assign a memory offset 234 to the portion 164. The memory offset 234 (e.g., 2 MB) may be a sum of the memory offset 232 and the size 192. The memory mapping engine 106 may assign a memory offset 236 to the portion 166. The memory offset 236 (2 MB+2 HPS) may be a sum of the memory offset 234 and the size 194.

FIG. 2 may illustrate a split-data approach, as described herein. The memory mapping engine 106 may generate the first data 132 based on a threshold number (e.g., 2) of entries of the descriptor data 176, as described with reference to FIG. 1. For example, the first data 132 may include the entry 140 corresponding to the portion 160, the entry 142 corresponding to the portion 162, or both.

The memory mapping engine 106 may generate the second data 138 based on the remaining entries of the descriptor data 176. For example, the memory mapping engine 106 may determine that the portion 164 includes a first number of segments based on the size 194 and a segment size. To illustrate, the memory mapping engine 106 may determine that the portion 164 includes the segment 152 and the segment 154 based on the size 194 and the HPS (e.g., the size 194/HPS=2 segments). The second data 138 may include the entry 124 corresponding to the segment 152 and the entry 126 corresponding to the segment 154, as described with reference to FIG. 1. The memory mapping engine 106 may determine the memory offset 234 corresponds to the segment 152 in response to determining that the segment 152 is an initial segment of the portion 164. The memory mapping engine 106 may determine a memory offset 238 of the segment 154 based on the memory offset 234 and the segment size (e.g., 2 MB+HPS).

The memory mapping engine 106 may translate between the memory offsets 110 of the contiguous memory model 202 used by the memory device 104 and the addresses used by the access device 170. For example, the memory mapping engine 106 may provide a memory offset to the memory device 104 as an address of a memory location in the allocated memory portions 108. The memory offset may be greater than or equal to the memory offset 230 (e.g., 0) and less than a largest offset in the contiguous memory model 202, e.g., a sum of the memory offset 236 and the size 196 (e.g., 2 MB+8 KB+4 KB). The memory mapping engine 106 may receive a memory access request (e.g., a read request or a write request) from the memory device 104. The memory access request may indicate the memory offset (e.g., a target offset).

The memory mapping engine 106 may select the first data 132 or the second data 138 based on the target offset. For example, the memory mapping engine 106 may select the first data 132 in response to determining that the target offset is less than a memory offset (e.g., the memory offset 234, such as 2 MB) of an initial entry (e.g., the entry 124) of the second data 138. The memory mapping engine 106 may select an entry (e.g., the entry 140 or the entry 142) of the first data 132 by performing a linear search of the first data 132. For example, the memory mapping engine 106 may select the entry 140 in response to determining that the target offset “matches” (e.g., is within a range associated with) the memory offset 230. The memory mapping engine 106 may determine that the target offset matches the memory offset 230 in response to determining that the target offset is greater than or equal to the memory offset 230 (e.g., 0) and less than a sum of the memory offset 230 and the size 190 (e.g., 0+1 MB). Alternatively, the memory mapping engine 106 may continue searching the first data 132 in response to determining that the target offset does not match the memory offset 230. For example, the memory mapping engine 106 may select the entry 142 in response to determining that the target offset matches the memory offset 232. To illustrate, the memory mapping engine 106 may determine that the target offset matches the memory offset 232 in response to determining that the target offset is greater than or equal to the memory offset 232 (e.g., 1 MB) and less than a sum of the memory offset 232 and the size 192 (e.g., 1 MB+1 MB).

In an alternate aspect, the memory mapping engine 106 may select the second data 138 in response to determining that the target offset is greater than or equal to the memory offset 234 (e.g., 2 MB). For example, the memory mapping engine 106 may select an nth entry of the second data 138 in response to determining that the target offset is greater than or equal to the memory offset 234 (e.g., 2 MB). The memory mapping engine 106 may select the nth entry based on the target offset, the memory offset 234, and the segment size (e.g., n=(target offset−the memory offset 234)/segment size). The memory mapping engine 106 may send a read request to the access device 170 to retrieve the nth entry (e.g., the entry 124, the entry 126, or the entry 128).

The memory mapping engine 106 may determine the target address based on an address indicated by the selected entry (e.g., the entry 140, the entry 142, the entry 124, the entry 126, or the entry 128), a memory offset of the selected entry, and the target offset. For example, the selected entry may include the entry 142 and the memory mapping engine 106 may determine the target address based on the address 182, the memory offset 232, and the target offset (e.g., target address=the address 182+target offset−the memory offset 232). As another example, the selected entry may include the entry 128 and the memory mapping engine 106 may determine the target address based on the address 188, the memory offset 238, and the target offset (e.g., target address=the address 188+target offset−the memory offset 238).

The memory mapping engine 106 may perform a memory operation (e.g., a read access or a write access) based on the target address, as described with reference to FIG. 1. For example, the controller 130 may receive a first memory request from the memory device 104 that indicates a target offset. The memory mapping engine 106 may determine a target address corresponding to the target offset and may send a second memory request to the access device 170 that indicates the target address.

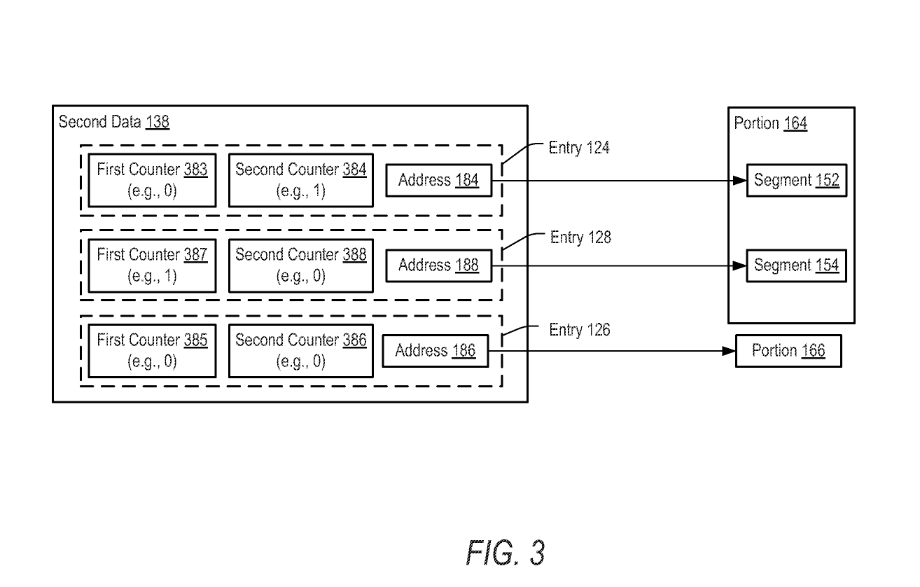

Referring to FIG. 3, a particular embodiment of the second data 138 is shown that includes counter values that may be used by the memory mapping engine 106 to compute portion information based on a location of a segment within the portion. For example, an entry of the second data 138 corresponding to a particular segment of a portion of the allocated memory portions 108 of FIG. 1 may include a counter indicating a number of segments prior to the particular segment in the portion. To illustrate, the entry 124 may include a first counter 383 indicating a number of segments (e.g., 0 segments) prior to the segment 152 in the portion 164. The entry 128 may include a first counter 387 indicating a number of segments (e.g., 1 segment) prior to the segment 154 in the portion 164. The entry 126 may include a first counter 385 indicating a number of segments (e.g., 0) prior to a segment corresponding to the portion 166. The portion 166 may correspond to a single segment.

In a particular aspect, an entry of the second data 138 corresponding to a particular segment of a portion of the allocated memory portions 108 of FIG. 1 may include a counter indicating a number of segments subsequent to the particular segment in the portion. To illustrate, the entry 124 may include a second counter 384 indicating a number of segments (e.g., 1 segment) subsequent to the segment 152 in the portion 164. The entry 128 may include a second counter 388 indicating a number of segments (e.g., 0 segments) subsequent to the segment 154 in the portion 164. The entry 126 may include a second counter 386 indicating a number of segments (e.g., 0) subsequent to a segment corresponding to the portion 166.

During a search of the second data 138, the memory mapping engine 106 may select an nth entry (e.g., the entry 124, the entry 126, or the entry 128) of the second data 138 in response to determining that a target offset is greater than or equal to a memory offset (e.g., the memory offset 234) of an initial entry (e.g., the entry 124) of the second data 138, as described with reference to FIG. 2. The nth entry may correspond to a particular segment (e.g., the segment 152, the segment 154, or the portion 166) of a particular portion (e.g., the portion 164 or the portion 166). For example, the nth entry may correspond to the segment 152 of the portion 164.

The memory mapping engine 106 may determine a first number of segments prior to the particular segment in the particular portion, a second number of segments subsequent to the particular segment in the particular portion, or both. For example, the memory mapping engine 106 may determine a first number of segments (e.g., 0) prior to the segment 152 based on the first counter 383, a second number of segments (e.g., 1) subsequent to the segment 152 based on the second counter 384, or both.

The memory mapping engine 106 may determine an address range based on the address 184, the first counter 383, the second counter 384, or a combination thereof. For example, the memory mapping engine 106 may determine a starting address of the address range based on the address 184, the first counter 383, and a segment size (e.g., starting address=the address 184−(the first counter 383*segment size)). The memory mapping engine 106 may determine an ending address of the address range based on the address 184, the second counter 384, and the segment size (e.g., ending address=the address 184+segment size+(the second counter 384*segment size)−1). The address range may correspond to a physical address range of the portion 164.

The memory mapping engine 106 may determine an offset range based on the target offset, the first counter 383, the second counter 384, or both. For example, the memory mapping engine 106 may determine a starting offset of the offset range based on the target offset, the first counter 383, and a segment size (e.g., starting offset=target offset−(the first counter 383*segment size)). The memory mapping engine 106 may determine an ending offset of the offset range based on the target offset, the second counter 384, and the segment size (e.g., ending offset=target offset+segment size+(the second counter 384*segment size)−1). The offset range may correspond to the address range. For example, a memory offset of the offset range may map to a particular address of the address range.

The controller 130 may receive a second memory request from the memory device 104 indicating a second target offset. The memory mapping engine 106 may, in response to determining that the offset range includes the second target offset, determine a second target address corresponding to the second target offset based on the target offset, the address 184, the second target offset, or a combination thereof. For example, the memory mapping engine 106 may, in response to determining that the offset range includes the second target offset and that the second target offset is less than the target offset, determine the second target address based on the address 184, the target offset, and the second target offset (e.g., second target address=address 184−(target offset−second target offset)). As another example, the memory mapping engine 106 may, in response to determining that the offset range includes the second target offset and that the second target offset is greater than the target offset, determine the second target address based on the address 184, the target offset, and the second target offset (e.g., second target address=address 184+(second target offset−target offset)).

The memory mapping engine 106 may thus determine target addresses corresponding to target offsets of a portion of the allocated memory portions 108 based on accessing an entry of the second data 138 that corresponds to a single segment of the portion. A number of data accesses with the access device 170 may be reduced when the second data 138 includes counter values.

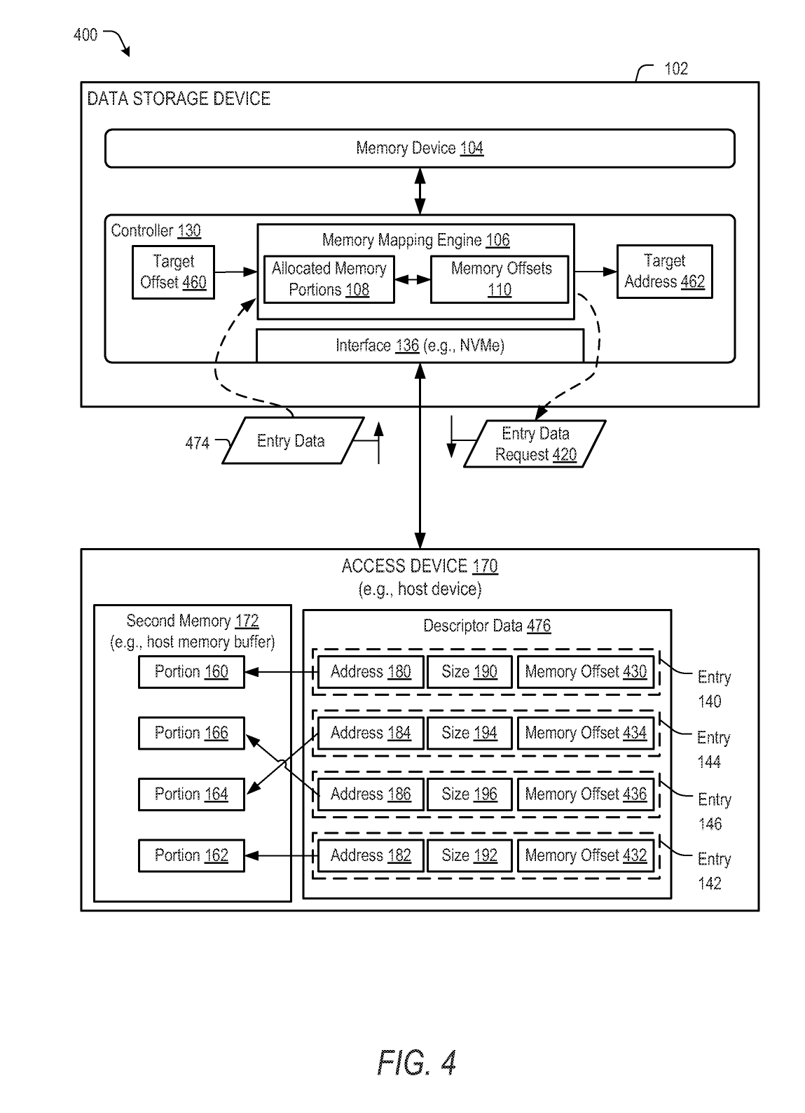

Referring to FIG. 4, a particular illustrative example of a system is depicted and generally designated 400. FIG. 4 may illustrate a modified descriptor data approach, as described herein.

The system 400 may differ from the system 100 in that entries of descriptor data 476 (e.g., a list) may include memory offsets. For example, the descriptor data 476 may include the entry 140, the entry 142, the entry 144, and the entry 146. The entry 140 may include a memory offset 430, the entry 142 may include a memory offset 432, the entry 144 may include a memory offset 434, and the entry 146 may include a memory offset 436.

The memory mapping engine 106 may receive the descriptor data 176 from the access device 170, as described with reference to FIG. 1. The memory mapping engine 106 may generate the descriptor data 476 based on the descriptor data 176. For example, the memory mapping engine 106 may copy the entries 140-146 of the descriptor data 176 to the descriptor data 476.

In some implementations, the memory mapping engine 106 may sort the entries 140-146 of descriptor data 476 based on the sizes 190-196 and may determine memory offsets based on the sorted descriptor data 476, as described with reference to FIG. 2. The memory offset 430 may correspond to the memory offset 230, the memory offset 432 may correspond to the memory offset 232, the memory offset 434 may correspond to the memory offset 234, and the memory offset 436 may correspond to the memory offset 236.

In some implementations, the memory mapping engine 106 may determine the memory offsets without an intermediate step of sorting the descriptor data 476. For example, in the unsorted descriptor data 476, the entry 144 may be subsequent to the entry 140, the entry 146 may be subsequent to the entry 144, and the entry 142 may be subsequent to the entry 146. The memory mapping engine 106 may determine the memory offset 430 based on a default value (e.g., 0), the memory offset 434 based on a sum of the memory offset 430 and the size 190, the memory offset 436 based on a sum of the memory offset 434 and the size 194, and the memory offset 432 based on a sum of the memory offset 436 and the size 196.

The memory mapping engine 106 may add the memory offset 430 to the entry 140, the memory offset 434 to the entry 144, the memory offset 436 to the entry 146, and the memory offset 432 to the entry 142.

The memory mapping engine 106 may provide the descriptor data 476 to the access device 170. The access device 170 may store the descriptor data 476 in the allocated memory portions 108. In a particular aspect, the access device 170 may replace (e.g., overwrite) the descriptor data 176 with the descriptor data 476. In a particular aspect, the memory mapping engine 106 may update the descriptor data 176 by adding the memory offsets 430-436 to the descriptor data 176. For example, the memory mapping engine 106 may add the memory offset 430 to the entry 140, the memory offset 434 to the entry 144, the memory offset 436 to the entry 146, and memory offset 432 to the entry 142. The memory mapping engine 106 may provide the updated descriptor data 176 to the access device 170. In a particular aspect, the memory mapping engine 106 may provide the memory offsets 430-436 to the access device 170 and the access device 170 may generate the descriptor data 476 based on the memory offsets 430-436.

During operation, the controller 130 may receive a memory access request (e.g., a read request or a write request) from the memory device 104 indicating a target offset 460. The memory mapping engine 106 may perform a search (e.g., a binary search) of the descriptor data 476 to determine a target address 462 corresponding to the target offset 460. For example, the memory mapping engine 106 may iteratively search the descriptor data 476 such that a particular iteration corresponds to fewer entries of the descriptor data 476 than a previous iteration, as described herein. A particular iteration may correspond to a set of entries of the descriptor data 476. During the particular iteration, the memory mapping engine 106 may compare the target offset 460 to a first memory offset indicated by a first entry of the set of entries. The first entry may be a middle entry of the set of entries. The memory mapping engine 106 may perform a subsequent iteration in response to determining that the target offset 460 does not match the first memory offset. The subsequent iteration may correspond to first entries that precede the first entry in the set of entries when the target offset 460 is less than the first memory offset. Alternatively, the subsequent iteration may correspond to second entries that are subsequent to the first entry in the set of entries when the target offset 460 is greater than or equal to a sum of the memory offset and the first size. The memory mapping engine 106 may thus search fewer than all entries of the descriptor data 476.

In a particular aspect, the memory mapping engine 106 may perform a search of the descriptor data 476 by sending a first entry data request (e.g., an entry data request 420) to the access device 170. The first entry data request (e.g., the entry data request 420) may indicate a first entry index (e.g., n/2, where n is an entry index of a last entry of the descriptor data 476). The first entry index may correspond to a middle entry (e.g., the entry 144) of the descriptor data 476. The access device 170 may send first entry data (e.g., entry data 474) corresponding to the first entry index (e.g., 1) to the controller 130 in response to receiving the first entry request (e.g., the entry data request 420). The first entry data (e.g., the entry data 474) may include the entry 144.

The memory mapping engine 106 may determine that the target offset 460 matches the memory offset 434 in response to determining that the target offset 460 is greater than or equal to the memory offset 434 and less than a sum of the memory offset 434 and the size 194. The memory mapping engine 106 may determine the target address 462 based on the address 184 in response to determining that the target offset 460 matches the memory offset 434 (e.g., the target address 462=the address 184+the target offset 460−the memory offset 434).

Alternatively, the memory mapping engine 106 may, in response to determining that the target offset 460 does not match the memory offset 434, continue searching the descriptor data 476. The memory mapping engine 106 may search the descriptor data 476 by sending a second entry data request (e.g., the entry data request 420) to the access device 170. The memory mapping engine 106 may search first entries preceding the entry 144 or second entries subsequent to the entry 144 based on a comparison of the target offset 460 and the memory offset 434. For example, the memory mapping engine 106 may generate the second entry data request (e.g., the entry data request 420) indicating a second entry index (e.g., n/4) in response to determining that the target offset 460 is less than the memory offset 434. The second entry index (e.g., 0) may correspond to a middle entry (e.g., the entry 140) of the first entries preceding the entry 144 in the descriptor data 476. As another example, the memory mapping engine 106 may generate the second entry data request (e.g., the entry data request 420) indicating a third entry index (e.g., 3n/4) in response to determining that the target offset 460 is greater than or equal to the memory offset 434. The third entry index (e.g., 2) may correspond to an entry that is a middle entry (e.g., the entry 146) of the second entries subsequent to the entry 144 in the descriptor data 476.

The access device 170 may send second entry data (e.g., the entry data 474) corresponding to the second entry index (e.g., 0 or 2) to the controller 130 in response to receiving the second entry request (e.g., the entry data request 420). For example, the second entry data may correspond to the entry 140 when the second entry index has a first value (e.g., 0) or to the entry 146 when the second entry index has a second value (e.g., 2). The memory mapping engine 106 may, in response to determining that the target offset 460 matches an offset (e.g., the memory offset 430 or the memory offset 436) indicated by the second entry data (e.g., the entry data 474), determine the target address 462 based on an address (e.g., the address 180 or the address 186) indicated by the second entry data (e.g., the entry data 474). Alternatively, the memory mapping engine 106 may, in response to determining that the target offset 460 does not match the offset indicated by the second entry data (e.g., the entry data 474), continue searching the descriptor data 476.

The system 400 may thus enable the memory mapping engine 106 to perform a search of the descriptor data 476 maintained at the access device 170. The search (e.g., a binary search) of the descriptor data 476 may be more efficient than a linear search of the descriptor data 476 (or the descriptor data 176). In a worst case scenario, whereas a linear search includes traversing all entries of the descriptor data 476, the system 400 may enable searching fewer than all entries of the descriptor data 476.

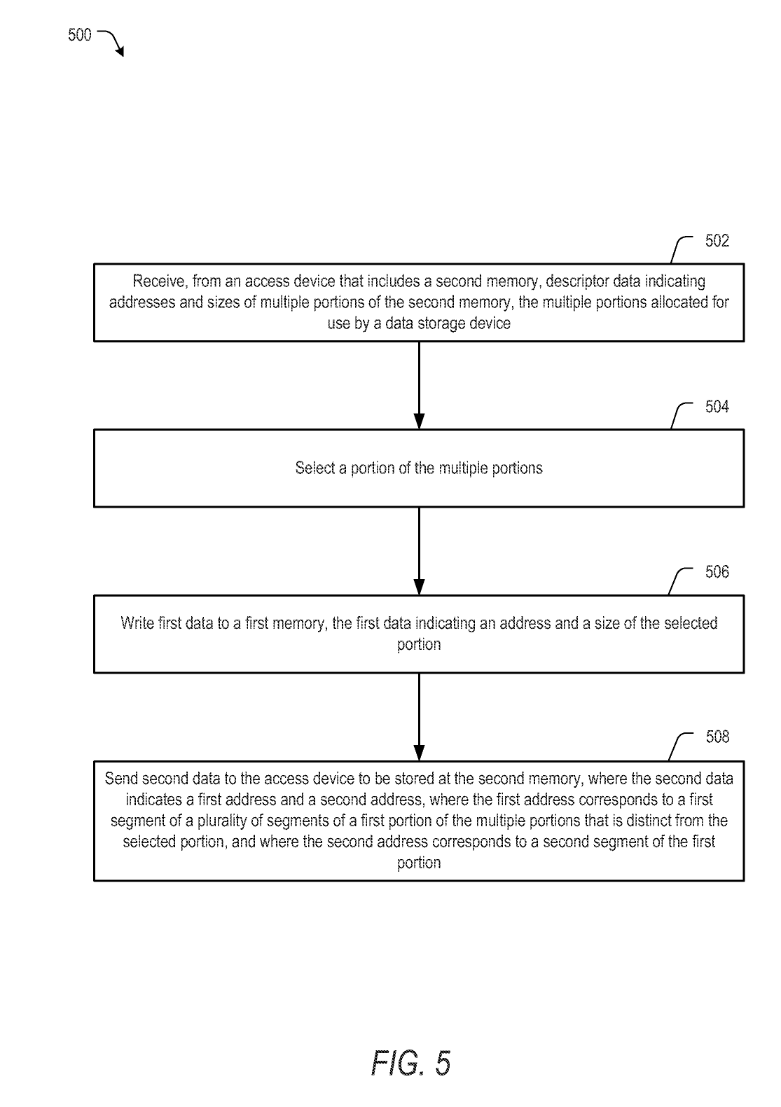

Referring to FIG. 5, an illustrative example of a method is depicted and generally designated 500. The method 500 may be performed by the data storage device 102, the controller 130, the memory mapping engine 106 of FIG. 1, or a combination thereof.

The method 500 includes receiving, from an access device that includes a second memory, descriptor data indicating addresses and sizes of multiple portions of the second memory, at 502. For example, the memory mapping engine 106 of FIG. 1 may receive the descriptor data 176 from the access device 170, as described with reference to FIG. 1. The access device 170 may include the second memory 172 of FIG. 1. The descriptor data 176 may include the addresses 180-186 and the sizes 190-196 of the portions 160-166. The portions 160-166 may be allocated by the access device 170 for use by the data storage device 102.

The method 500 also includes selecting a portion of the multiple portions, at 504. For example, the memory mapping engine 106 of FIG. 1 may select the portion 160 of the portions 160-166 for local storage of the descriptor data (e.g., at the first memory 134), as described with reference to FIG. 1.

The method 500 further includes writing first data to a first memory, at 506. For example, the memory mapping engine 106 of FIG. 1 may write the first data 132 to the first memory 134, as described with reference to FIG. 1. The first data 132 may indicate the address 180 and the size 190 of the portion 160.

The method 500 also includes sending second data to the access device to be stored at the second memory, at 508. For example, the memory mapping engine 106 of FIG. 1 may send the second data 138 to the access device 170 to be stored at the second memory 172, as described with reference to FIG. 1. The second data 138 may indicate the address 184 and the address 188 of the segments 152 and 154 of the portion 164 (that is distinct from the selected portion 160).

The method 500 may enable the memory mapping engine 106 to balance utilization of the first memory 134 and data transfers with the access device 170 by maintaining the first data 132 in the first memory 134 of the controller 130 and maintaining the second data 138 in the second memory 172 of the access device 170. The first data 132 may include a few (e.g., up to a threshold number of) entries corresponding to some of the larger portions of the allocated memory portions 108. The second data 138 may include entries corresponding to remaining portions of the allocated memory portions 108. The memory mapping engine 106 may determine a target address corresponding to a target offset by performing a linear search on the first data 132 that is stored locally on the controller 130 or by performing a single lookup in the entries of the second data 138 that is stored at the access device 170. The single lookup may reduce a number of data transfers with the access device 170 as compared to a linear search of the second data 138.

In some implementations, a computer-readable medium stores instructions executable by a processing module to perform operations. For example, the computer-readable medium may correspond to the first memory 134, the instructions may correspond to the instructions 163, and the processing module may correspond to the memory mapping engine 106. The operations include receiving descriptor data (e.g., the descriptor data 176) from an access device (e.g., the access device 170) that includes a second memory (e.g., the second memory 172) and selecting a portion (e.g., the portion 160) of multiple portions (e.g., the portions 160-166) of the second memory (e.g., the second memory 172). The operations also include maintaining, at a first memory (e.g., the first memory 134), data (e.g., the first data 132) indicating an address (e.g., the address 180) and a size (e.g., the size 190) of the selected portion (e.g., the portion 160). The operations further include sending second data (e.g., the second data 138) to the access device (e.g., the access device 170) to be stored at the second memory (e.g., the second memory 172). The second data (e.g., the second data 138) may indicate a first address (e.g., the address 184) and a second address (e.g., the address 188).

Although various components depicted herein are illustrated as block components and described in general terms, such components may include one or more microprocessors, state machines, or other circuits configured to enable such components to perform one or more operations described herein. For example, the memory mapping engine 106 may represent physical components, such as hardware controllers, state machines, logic circuits, or other structures, to enable the controller 130 to maintain the first data 132 at the first memory 134 and to send the second data 138 to the access device 170 to be stored at the second memory 172.

Alternatively or in addition, one or more components described herein may be implemented using a microprocessor or microcontroller programmed to perform operations, such as one or more operations of the method 500 of FIG. 5. Instructions executed by the memory mapping engine 106, the controller 130 and/or the data storage device 102 may be retrieved from the first memory 134 or from a separate memory location that is not part of the first memory 134, such as from a read-only memory (ROM).

The data storage device 102 may be coupled to, attached to, or embedded within one or more accessing devices, such as within a housing of the access device 170. For example, the data storage device 102 may be embedded within the access device 170 in accordance with a Joint Electron Devices Engineering Council (JEDEC) Solid State Technology Association Universal Flash Storage (UFS) configuration. To further illustrate, the data storage device 102 may be integrated within an electronic device, such as a mobile telephone, a computer (e.g., a laptop, a tablet, or a notebook computer), a music player, a video player, a gaming device or console, a component of a vehicle (e.g., a vehicle console), an electronic book reader, a personal digital assistant (PDA), a portable navigation device, or other device that uses internal non-volatile memory.

In one or more other implementations, the data storage device 102 may be implemented in a portable device configured to be selectively coupled to one or more external devices, such as a host device. For example, the data storage device 102 may be removable from the access device 170 (i.e., “removably” coupled to the device). As an example, the data storage device 102 may be removably coupled to the access device 170 in accordance with a removable universal serial bus (USB) configuration.

In some implementations, the system 100, the data storage device 102, or the first memory 134 may be integrated within a network-accessible data storage system, such as an enterprise data system, an NAS system, or a cloud data storage system, as illustrative examples. In some implementations, the data storage device 102 may include a solid state drive (SSD). The data storage device 102 may function as an embedded storage drive (e.g., an embedded SSD drive of a mobile device), an enterprise storage drive (ESD), a cloud storage device, a network-attached storage (NAS) device, or a client storage device, as illustrative, non-limiting examples. In some implementations, the data storage device 102 may be coupled to the access device 170 via a network. For example, the network may include a data center storage system network, an enterprise storage system network, a storage area network, a cloud storage network, a local area network (LAN), a wide area network (WAN), the Internet, and/or another network.

To further illustrate, the data storage device 102 may be configured to be coupled to the access device 170 as embedded memory, such as in connection with an embedded MultiMedia Card (eMMC®) (trademark of JEDEC Solid State Technology Association, Arlington, Va.) configuration, as an illustrative example. The data storage device 102 may correspond to an eMMC device. As another example, the data storage device 102 may correspond to a memory card, such as a Secure Digital (SD®) card, a microSD® card, a miniSD™ card (trademarks of SD-3C LLC, Wilmington, Del.), a MultiMediaCard™ (MMC™) card (trademark of JEDEC Solid State Technology Association, Arlington, Va.), or a CompactFlash® (CF) card (trademark of SanDisk Corporation, Milpitas, Calif.). The data storage device 102 may operate in compliance with a JEDEC industry specification. For example, the data storage device 102 may operate in compliance with a JEDEC eMMC specification, a JEDEC Universal Flash Storage (UFS) specification, one or more other specifications, or a combination thereof.

The first memory 134 and/or the memory device 104 may include a resistive random access memory (ReRAM), a flash memory (e.g., a NAND memory, a NOR memory, a single-level cell (SLC) flash memory, a multi-level cell (MLC) flash memory, a divided bit-line NOR (DINOR) memory, an AND memory, a high capacitive coupling ratio (HiCR) device, an asymmetrical contactless transistor (ACT) device, or another flash memory), an erasable programmable read-only memory (EPROM), an electrically-erasable programmable read-only memory (EEPROM), a read-only memory (ROM), a one-time programmable memory (OTP), another type of memory, or a combination thereof. In a particular embodiment, the data storage device 102 is indirectly coupled to the access device 170 via a network. For example, the data storage device 102 may be a network-attached storage (NAS) device or a component (e.g., a solid-state drive (SSD) component) of a data center storage system, an enterprise storage system, or a storage area network. The first memory 134 and/or the memory device 104 may include a semiconductor memory device.

Semiconductor memory devices include volatile memory devices, such as dynamic random access memory (“DRAM”) or static random access memory (“SRAM”) devices, non-volatile memory devices, such as resistive random access memory (“ReRAM”), magnetoresistive random access memory (“MRAM”), electrically erasable programmable read only memory (“EEPROM”), flash memory (which can also be considered a subset of EEPROM), ferroelectric random access memory (“FRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure. In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate). As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Alternatively, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically used for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this disclosure is not limited to the two dimensional and three dimensional exemplary structures described but cover all relevant memory structures within the spirit and scope of the disclosure as described herein and as understood by one of skill in the art. The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure.

The above-disclosed subject matter is to be considered illustrative, and not restrictive, and the appended claims are intended to cover all such modifications, enhancements, and other embodiments, that fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A data storage device comprising:
a non-volatile memory device; and
a controller including a first memory, the controller coupled to the non-volatile memory device, wherein the controller is configured to:
receive, from an access device that includes a second memory, descriptor data indicating addresses and sizes of multiple portions of the second memory, the multiple portions allocated for use by the controller;
select a largest portion of the multiple portions;
write first data to the first memory, the first data indicating an address and a size of the selected portion; and
send a write request indicating second data and a particular address of a particular portion of the multiple portions to the access device to cause storage of the second data at the particular portion of the second memory, wherein:
the second data indicates a first address and a second address;
the first address corresponds to a first segment of a plurality of segments of a first portion of the multiple portions that is distinct from the selected portion; and
the second address corresponds to a second segment of the plurality of segments.

2. The data storage device of claim 1, wherein the selected portion is selected based on the size of the selected portion.

3. The data storage device of claim 1, wherein the second data does not include size information of the first portion.

4. The data storage device of claim 1, wherein the controller is further configured to:
identify an entry index of an entry of the second data based at least in part on a first target offset of a first target portion, wherein:
the entry indicates the first address of the first segment, a first counter value, and a second counter value;
the first counter value indicates a first number of segments prior to the first segment in the first portion; and
the second counter value indicates a second number of segments subsequent to the first segment in the first portion;
determine a first target address corresponding to the first target offset based on the first address indicated by the entry;
determine an offset range based on the first target offset, the first counter value indicated by the entry, and the second counter value indicated by the entry; and
in response to determining that the offset range includes a second target offset, determine a second target address corresponding to the second target offset based on the first target offset, the second target offset, and the first address.

5. The data storage device of claim 1, wherein the second data includes table entries corresponding to equally-sized segments of the first portion.

6. The data storage device of claim 1, wherein the descriptor data includes a list of the addresses and the sizes of the multiple portions.

7. The data storage device of claim 6, wherein the controller is further configured to sort the list based on the sizes of the multiple portions.

8. (canceled)

9. The data storage device of claim 7, wherein:
the multiple portions are non-contiguous:
the controller is further configured to map the addresses of the multiple portions to a contiguous address range by determining memory offsets of the multiple portions based on the sorted list;
a memory offset of a second particular portion is based on a first memory offset and a first size of a first particular portion; and
the first particular portion precedes the second particular portion in the sorted list.

10. The data storage device of claim 1, wherein the controller is further configured to:
select one of the first data or the second data based on a memory offset of a target portion of the multiple portions; and
determine a target address of the target portion based on the memory offset and the selected one of the first data or the second data.

11. The data storage device of claim 1, wherein the controller is further configured to, in response to determining that a target offset of a target portion is less than a memory offset indicated by the second data, perform a linear search of the first data to determine a target address corresponding to the target offset, wherein the memory offset corresponds to an initial entry of the second data.

12. The data storage device of claim 1, wherein the controller is further configured to, in response to determining that a target offset of a target portion is greater than or equal to a memory offset indicated by the second data:
identify an entry index of an entry of the second data based on the target offset and an entry size, and
determine a target address corresponding to the target offset based on an address indicated by the entry,
wherein the memory offset corresponds to an initial entry of the second data.

13. A method comprising:
at a data storage device that includes a controller coupled to a non-volatile memory device, the controller including a first memory and the data storage device coupled to an access device that includes a second memory, performing:
receiving, from the access device, descriptor data indicating addresses and sizes of multiple portions of the second memory, the multiple portions allocated for use by the data storage device;
selecting a largest portion of the multiple portions;
writing first data to the first memory, the first data indicating an address and a size of the selected portion; and
sending a write request indicating second data and a particular address of a particular portion of the multiple portions to the access device, the write request causing storage of the second data at the particular portion of the second memory, wherein:
the second data indicates a first address and a second address;
the first address corresponds to a first segment of a plurality of segments of a first portion of the multiple portions that is distinct from the selected portion; and
the second address corresponds to a second segment of the plurality of segments.

14. The method of claim 13, wherein the access device includes a host device.

15. The method of claim 13, further comprising selecting one or more additional portions from the remaining portions of the multiple portions, wherein the first data indicates a corresponding address and a corresponding size of each of the one or more additional portions.

16. The method of claim 13, further comprising determining memory offsets of the multiple portions based on the descriptor data.

17. A device comprising:
means for receiving, from an access device that includes a second memory, entry data corresponding to a first entry of multiple entries of a descriptor list, wherein: the multiple entries include addresses, sizes, and offsets of multiple portions of the second memory;
the multiple portions are allocated for use by a controller coupled to a non-volatile memory device;
the first entry includes a first offset of a first portion of the multiple portions; and
the multiple entries are sorted based on the offsets;
means for determining a target address corresponding to a target portion of the multiple portions by searching the descriptor list based on a comparison of the first offset to a target offset of the target portion; and
means for sending a memory operation request indicating the target address to the access device to cause the access device to perform a memory operation based on the target address.

18. The device of claim 17, wherein searching the descriptor list includes performing a binary search of the descriptor list.

19. The device of claim 17,
wherein searching the descriptor list includes:
sending an entry data request to the access device; and
receiving second entry data responsive to the entry data request, the second entry data corresponding to a second entry of the multiple entries of the descriptor list,
wherein the second entry includes a second address of the addresses and a second offset of the offsets, and
wherein the target address is determined to include the second address in response to determining that the target offset matches the second offset.

20. The device of claim 17, further comprising:
means for determining the offsets based on the addresses and sizes:
means for updating the descriptor list to add the offsets to the multiple entries; and
means for sending the updated descriptor list to the access device.
